(19) United States
(12) Patent Application Publication
(10) Pub. No.: US 2024/0302779 A1
(43) Pub. Date: Sep. 12, 2024

(54) IMAGE FORMING APPARATUS CAPABLE OF SIMPLIFYING CONTROL CIRCUIT

(71) Applicant: KYOCERA Document Solutions Inc., Osaka (JP)

(72) Inventors: Atsuki Ito, Osaka (JP); Ayato Morikami, Osaka (JP); Yasuaki Sakamoto, Osaka (JP); Masaru Watanabe, Osaka (JP); Yukiko Kotani, Osaka (JP); Makoto Matsumoto, Osaka (JP)

(21) Appl. No.: 18/590,829

(22) Filed: Feb. 28, 2024

(30) Foreign Application Priority Data
Mar. 6, 2023 (JP) 2023-033544

(51) Int. Cl. G03G 15/00; G03G 15/01; G03G 15/043; G03G 15/05; G03G 15/16; G06K 15/02

(52) U.S. Cl. CPC G03G 15/5041; G03G 15/011; G03G 15/0121; G03G 15/0131; G03G 15/0189; G03G 15/043; G03G 15/05; G03G 15/1605; G03G 15/5054; G06K 15/027

(57) ABSTRACT

A control portion, by an image density sensor detecting density of reference images for image density correction formed by a plurality of image forming portions, adjusts a developing voltage and an exposure amount of an exposure device based on the detection result. The control portion, based on the density of the reference images detected by the image density sensor, sets a common developing voltage such that the densities of the reference images are equal to or higher than a target density in all of the two or more image forming portions among the plurality of image forming portions. The control portion, by adjusting a toner adhesion area ratio for image forming portions of the two or more image forming portions in which the densities of the reference images exceed the target density when a common developing voltage is set, adjusts the densities of the reference images to the target density.

### INCORPORATION BY REFERENCE

This application is based upon and claims the benefit of priority from the corresponding Japanese Patent Application No. 2023-033544 filed on Mar. 6, 2023, the entire contents of which are incorporated herein by reference.

### BACKGROUND

The present disclosure relates to an image forming apparatus using an electrophotographic process, and particularly relates to a method for adjusting image density using a toner density sensor.

In an electrophotographic image forming apparatus, density of a formed image may change due to changes in the photoconductor and toner over time, changes in temperature and humidity around the apparatus, and the like. Therefore, conventionally, a technology has been proposed that performs image density adjustment (calibration) at a predetermined timing to stabilize image formation against the above changes.

In this image density adjustment, adjustments are made to an optimal charging voltage, developing voltage, exposure amount, gradation characteristic processing (gamma correction), and the like in order to output a target image density. However, since the optimal charging voltage, developing voltage, exposure amount, and gradation characteristic settings differ for each toner color, it is a common to provide an adjustment circuit for each color, which results in a problem of increased circuit size and cost.

Therefore, methods have been proposed to simplify the circuit structure. For example, a liquid crystal device is known in which gamma correction is performed for a plurality of colors using the gamma characteristics of one reference color, the image data after gamma correction is converted to an analog signal, and for colors with different gamma characteristics, a simple adjustment circuit is used to increase or decrease predetermined voltage for the analog signals thereof. Thus, it possible to reduce memory capacity for storing a lookup table indicating gamma characteristics for each color, and to simplify the gamma correction circuit.

### SUMMARY

A first aspect according to the present disclosure is an image forming apparatus that includes a plurality of image forming portions, an exposure device, an image density sensor, a developing voltage supply mechanism, and a control portion. Each of the plurality of image forming portions has an image-carrying member with a photosensitive layer formed on a surface thereof; a charging device configured to charge the surface of the image-carrying member; and a developing device configured to develop an electrostatic latent image formed on the image-carrying member into a toner image using a developing-agent-carrying member carrying a developing agent including a toner; and the plurality of image forming portions are configured to perform image formation using the toners of a plurality of colors with different developability. The exposure device is configured to expose the surface of the image-carrying member charged by the charging device to form the electrostatic latent image in which charging is attenuated. The image density sensor is configured to detect densities of the toner images formed by the image forming portions. The developing voltage supply mechanism is configured to apply a developing voltage to the developing-agent-carrying member. The control portion is configured to control the developing voltage supply mechanism and the exposure device. The control portion, by the image density sensor detecting densities of reference images for image density correction formed by the plurality of image forming portions and adjusting the developing voltage and an exposure amount of the exposure device based on the detected result, is capable of executing image density correction to adjust image densities in the plurality of image forming portions. The control portion, based on the densities of the reference images detected by the image density sensor, sets a common developing voltage such that the densities of the reference images are equal to or higher than a target density in all of the two or more image forming portions selected from the plurality of image forming portions. The control portion, by adjusting an adhesion area ratio of the toner for the image forming portions of the two or more selected image forming portions in which the densities of the reference images exceed the target density when a common developing voltage is set, adjusts the densities of the reference images to the target density.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing an internal configuration of an image forming apparatus 100 of an embodiment according to the present disclosure.

FIG. 2 is an enlarged view of a vicinity of an image forming portion Pa in FIG. 1.

FIG. 3 is a diagram showing an example of a reference image for image density correction.

FIG. 4 is a block diagram showing an example of a control path of the image forming apparatus 100 of the present embodiment.

FIG. 5 is a flowchart showing an example of control of image density correction executed by the image forming apparatus 100 of the present embodiment.

### DETAILED DESCRIPTION

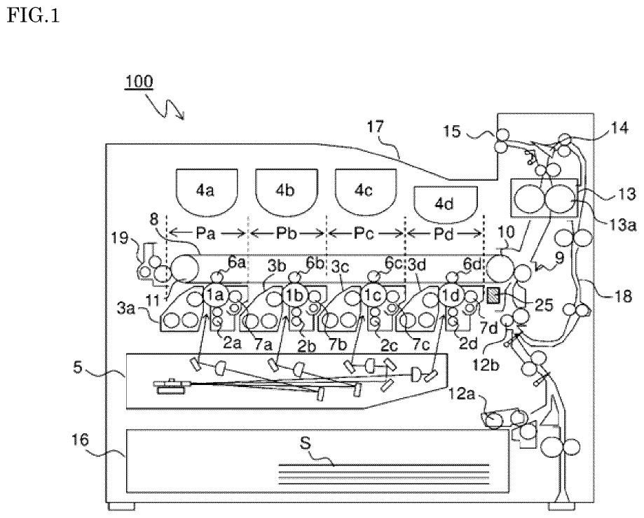

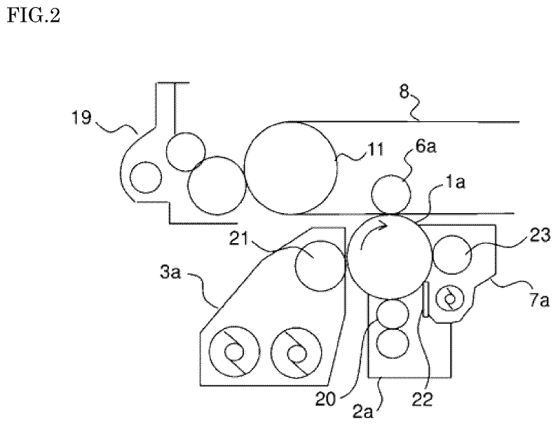

Embodiments according to the present disclosure will be described hereinafter with reference to the drawings. FIG. 1 is a schematic diagram showing the configuration of an image forming apparatus 100 according to an embodiment of the present disclosure. FIG. 2 is an enlarged view of a vicinity of an image forming portion Pa in FIG. 1.

The image forming apparatus 100 shown in FIG. 1 is a so-called tandem color printer, and has the following configuration. Four image forming portions Pa, Pb, Pc, and Pd are arranged in a main body of the image forming apparatus 100 in order from an upstream side in a conveying direction (left side in FIG. 1). These image forming portions Pa to Pd are provided corresponding to images of four different colors (yellow, cyan, magenta, and black), and sequentially form yellow, cyan, magenta and black images by steps of charging, exposing, developing and transferring.

These image forming portions Pa to Pd are provided with photoconductor drums 1a, 1b, 1c, and 1d that carry visible images (toner images) of each color. Furthermore, in FIG. 1, an intermediate transfer belt 8 that rotates in a counterclockwise direction is provided adjacent to each of the image forming portions Pa to Pd. After the toner images formed on these photoconductor drums 1a to 1d are sequentially transferred onto the intermediate transfer belt 8 that moves while coming in contact with each of the photoconductor drums 1a to 1d, in a secondary transfer unit 9, the images are transferred all at once onto a sheet of paper S as an example of a recording medium. Furthermore, the toner image transferred onto the paper is fixed onto the paper S by a fixing portion 13. Then, the paper S with the toner image fixed thereon is discharged from the main body of the image forming apparatus 100. The image forming apparatus 100 executes an image forming process on each of the photoconductor drums 1a to 1d while rotating the photoconductor drums 1a to 1d in a clockwise direction in FIG. 1.

The paper S to which the toner image is transferred is stored in a paper cassette 16 at a lower portion of the main body of the image forming apparatus 100, and is conveyed to a secondary transfer roller 9 via a paper feed roller 12a and a registration roller pair 12b. A belt having no seams (seamless) is mainly used as the intermediate transfer belt 8.

Next, the image forming portions Pa to Pd will be explained. The image forming portion Pa will be described in detail below; however, since the image forming portions Pb to Pd have basically the same configuration, descriptions of them will be omitted. As shown in FIG. 2, a charging device 2a, a developing device 3a, and a cleaning device 7a are arranged around the photoconductor drum 1a along the drum rotation direction (clockwise direction in FIG. 2), and the intermediate transfer belt 8 is arranged between a primary transfer roller 6a and the photoconductor drum 1a. In addition, a belt cleaning unit 19 is arranged on an upstream side in a rotational direction of the intermediate transfer belt 8 with respect to the photoconductor drum 1a, and faces a tension roller 11 with the intermediate transfer belt 8 in between.

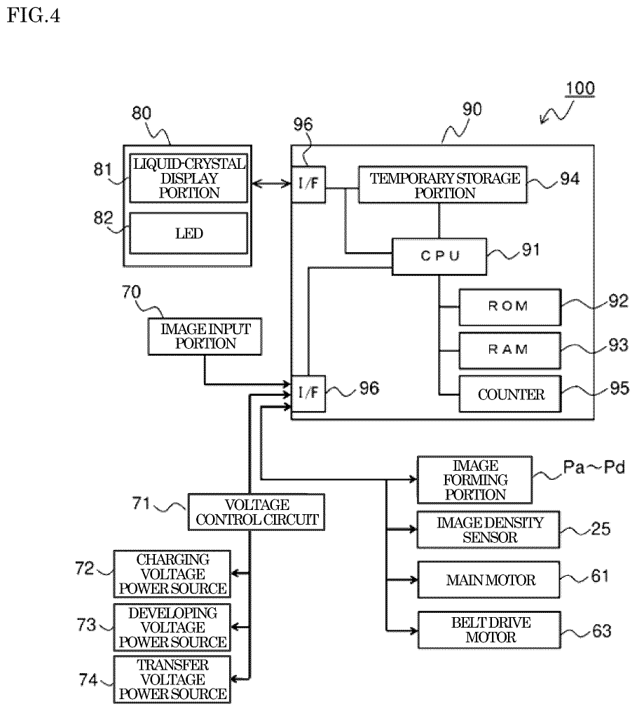

Next, an image forming procedure in the image forming apparatus 100 will be described. When the user starts image formation, first, a main motor 61 (see FIG. 4) starts rotating the photoconductor drums 1a to 1d, and the surfaces of the photoconductor drums 1a to 1d are uniformly charged by the charging rollers 20 of the charging devices 2a to 2d. Next, the surfaces of the photoconductor drums 1a to 1d are irradiated with a beam of light (laser light) emitted from the exposure device 5, and electrostatic latent images are formed on each of the photoconductor drums 1a to 1d according to an image signal.

Developing devices 3a to 3d are respectively filled with a predetermined amount of toner of each color: yellow, cyan, magenta, and black. Note that in a case where the ratio of toner in a two-component developing agent filled in each of the developing devices 3a to 3d falls below a specified value due to the formation of toner images described below, toner is replenished from toner containers 4a to 4d to the developing devices 3a to 3d, respectively. The toner in this developing agent is supplied onto the photoconductor drums 1a to 1d by the developing rollers 21 of the developing devices 3a to 3d, and electrostatically adheres to the photoconductor drums 1a to 1d. Thus, a toner image corresponding to an electrostatic latent image formed by exposure from the exposure device 5 is formed.

An electric field is applied at a predetermined transfer voltage between primary transfer rollers 6a to 6d and the photoconductor drums 1a to 1d by the primary transfer rollers 6a to 6d, and the yellow, cyan, magenta, and black toner images on the photoconductor drums 1a to 1d are primarily transferred onto the intermediate transfer belt 8. These four-color images are formed in a predetermined positional relationship for forming a specified full-color image. After that, in preparation for subsequent formation of a new electrostatic latent image, the toner remaining on the surfaces of the photoconductor drums 1a to 1d is removed by cleaning blades 22 and scrub rollers 23 of the cleaning devices 7a to 7d.

When the intermediate transfer belt 8 starts rotating in the counterclockwise direction with the rotation of a drive roller 10 by a belt drive motor 63 (see FIG. 4), the paper S is conveyed from the registration roller pair 12b to the secondary transfer roller 9 provided adjacent to the intermediate transfer belt 8 at a predetermined timing, and a full color image is transferred thereto. The paper S onto which the toner image has been transferred is conveyed to the fixing portion 13. Toner remaining on the surface of the intermediate transfer belt 8 is removed by the belt cleaning unit 19.

The paper S conveyed to the fixing portion 13 is heated and pressurized by a pair of fixing rollers 13a. Thus, the toner image is fixed on a surface of the paper S, and a predetermined full-color image is formed. The paper S on which a full-color image has been formed is sorted in the conveying direction by a branching portion 14 that is branched into multiple directions, and is discharged as is (or after being sent to a double-side conveying path 18 and printed on both sides) by a discharge roller pair 15 onto a discharge tray 17.

An image density sensor 25 is arranged at a position facing the drive roller 10 with the intermediate transfer belt 8 interposed therebetween. As the image density sensor 25, an optical sensor is generally used that includes a light emitting element such as an LED and a light receiving element such as a photodiode. When the amount of toner adhesion on the intermediate transfer belt 8 is measured, measurement light is irradiated from a light emitting element to each patch image (reference image) formed on the intermediate transfer belt 8, and the measurement light is incident on the light receiving element as light reflected by the toner and light reflected by the belt surface.

The reflected light from the toner and belt surfaces includes specularly reflected light and diffusely reflected light. The specularly reflected light and the diffusely reflected light are separated by a polarization separation prism, and then enter separate light receiving elements. Each light receiving element photoelectrically converts the received specularly reflected light and diffusely reflected light and outputs an output signal to a control portion 90 (see FIG. 4).

In the image forming apparatus 100, the image density (toner amount) and image position of a patch image are detected from changes in the characteristics of output signals of specularly reflected light and diffusely reflected light, and compared with predetermined reference concentration and reference position, and by adjusting the characteristic value of the developing voltage, the exposure start position and timing of the exposure device 5, and the like, image density correction and color slippage correction (calibration) are performed for each color.

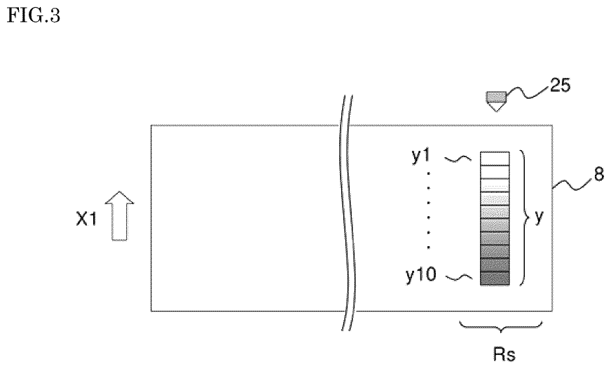

FIG. 3 is a diagram showing an example of a patch image (reference image) for image density correction. On one side (right side) of a reference image forming area Rs of the intermediate transfer belt 8, a reference image y is formed that includes patch images y1 to y10 having 10 density levels from the lightest color image y1 to the darkest color image y10 that are sequentially formed in a line from the downstream side along the belt traveling direction (arrow X1 direction). Adjacent patch images are each formed in a single color so that the density changes at the boundary. Note that although the yellow reference image y has been described here as an example, cyan, magenta, and black reference images c, m, and k have exactly the same configuration.

In the image forming apparatus 100, the toner adhesion amounts (toner densities) of the reference images y to k are detected by the image density sensor 25 and compared with a predetermined reference density, and an average value of density differences between each toner density and the reference density is determined. In accordance with the average value of the obtained density differences, parameter values used for density correction are determined as will be described later, and density correction is executed for each color.

FIG. 4 is a block diagram showing an example of a control path of the image forming apparatus 100 of the present embodiment. Note that when using the image forming apparatus 100, various controls are performed by the portions of the apparatus, and thus the control path for the entire image forming apparatus 100 becomes complicated. Therefore, the portions of the control path that are necessary for implementing the technique according to the present disclosure will be mainly described here.

The control portion 90 includes a central processing unit (CPU) 91 as a central processing unit, a read only memory (ROM) 92 that is a read-only storage portion, a random access memory (RAM) 93 that is a readable and writable storage portion, a temporary storage portion 94 that stores image data and the like, a counter 95, and a plurality (two here) of interfaces (I/Fs) 96 that transmit control signals to each device in the image forming apparatus 100 and receive input signals from an operation portion 80. In addition, the control portion 90 may be placed at any location inside the main body of the image forming apparatus 100.

The ROM 92 stores a control program for controlling the image forming apparatus 100, numerical values and the like necessary for control, and data and the like that will not be changed while the image forming apparatus 100 is in use. The RAM 93 stores necessary data generated during control of the image forming apparatus 100, data temporarily required for controlling the image forming apparatus 100, and the like. In addition, the RAM 93 (or ROM 92) also stores image density correction tables, lookup tables, and the like used for calibration. The counter 95 adds up and counts the number of printed sheets.

Moreover, the control portion 90 transmits control signals from the CPU 91 to each part and device in the image forming apparatus 100 through the I/Fs 96. Furthermore, signals from each part and device to indicate status thereof and input signals are transmitted to the CPU 91 via the I/Fs 96. Examples of the parts and devices controlled by the control portion 90 include the image forming portions Pa to Pd, the main motor 61, the belt drive motor 63, an image input portion 70, the voltage control circuit 71, the operation portion 80, and the like.

The image input portion 70 is a receiving portion that receives image data transmitted to the image forming apparatus 100 from a host device such as a personal computer. The image signal input from the image input portion 70 is converted into a digital signal and then sent to the temporary storage portion 94.

The voltage control circuit 71 is connected to a charging voltage power source 72, a developing voltage power source 73, and a transfer voltage power source 74, and operates each of the power sources according to an output signal from the control portion 90. The charging voltage power source 72 applies a predetermined charging voltage to the charging rollers 20 in the charging devices 2a to 2d according to a control signal from the voltage control circuit 71. The developing voltage power source 73 applies a predetermined developing voltage, in which an alternating current voltage is superimposed on a direct current voltage, to the developing rollers 21 in the developing devices 3a to 3d according to a control signal from the voltage control circuit 71. The transfer voltage power source 74 applies predetermined transfer voltage to each of the primary transfer rollers 6a to 6d and the secondary transfer roller 9 according to a control signal from the voltage control circuit 71.

The operation portion 80 is provided with a liquid-crystal display portion 81 and an LED 82 that indicates various states. The user operates a stop/clear button on the operation portion 80 to stop image formation, and operates a reset button to set various settings of the image forming apparatus 100 to a default state. The liquid-crystal display portion 81 is configured to show the state of the image forming apparatus 100, the image forming state, and the number of copies to be printed. Various settings of the image forming apparatus 100 are performed from a printer driver of a personal computer.

In image density correction (calibration), adjustments are made to the optimal charging voltage, developing voltage, exposure amount, gradation characteristic processing (gamma correction), and the like in order to output a target image density. However, since the optimal charging voltage, developing voltage, exposure amount, and gradation characteristics settings differ for each toner color, it is common to provide an adjustment circuit for each color, which results in a problem of increased a circuit size and cost.

Therefore, methods have been proposed to simplify the circuit structure. For example, a liquid crystal device is known in which gamma correction is performed for a plurality of colors using the gamma characteristics of one reference color, the image data after gamma correction is converted to an analog signal, and for colors with different gamma characteristics, a simple adjustment circuit is used to increase or decrease predetermined voltage for the analog signals thereof. Thus, it possible to reduce memory capacity for storing a lookup table indicating gamma characteristics for each color, and to simplify the gamma correction circuit.

However, in the above-mentioned liquid-crystal device, due to a circuit configuration that increases or decreases a predetermined voltage, a restriction occurs in that the output after gamma correction performed for colors with different gamma characteristics must be linear with respect to the original output after gamma correction.

On the other hand, in the image forming apparatus 100 of the present embodiment according to the present disclosure, as will be described below, it is possible to simplify the control circuit required to execute calibration for the plurality of colors of toners having different developability.

In the following, a procedure for executing image density correction in the image forming portions Pa to Pd, which is a feature according to the present disclosure, will be described. In the image forming apparatus 100 of the present embodiment, the voltage control circuit 71 sets a common developing voltage for the plurality of toner colors having different developability so that the image densities of all the plurality of colors become equal to or higher than a target density. For colors whose image density exceeds the target density, an area ratio of the toner image is adjusted to reach the target density. Each process of image density adjustment will be described in detail below.

### (Developing Voltage Adjustment Process)

In a case of performing image density correction, the control portion 90 first adjusts the developing voltage applied to the developing rollers 21 of the developing devices 3a to 3d. Here, as an example, a case will be described in which the developing voltages for the three colors of yellow, cyan, and magenta are set in common.

Specifically, the control portion 90, together with changing the developing voltage (DC voltage), determines the surface potential (charging voltage) of the photoconductor drums 1a to 1c according to the developing voltage, and on the intermediate transfer belt 8, forms a plurality of reference images y to m (see FIG. 3) in which the amount of toner adhesion is changed in steps. The image density sensor 25 reads the formed reference images y to m. The control portion 90 sets the developing voltage based on the voltage detected by the image density sensor 25. A common developing voltage is set so that the image density of the color with the lowest image density (for example, yellow) among the three colors yellow, cyan, and magenta becomes the target density. The set value (target value) of the developing voltage may be determined by linear interpolation by graphing the detected voltages of the plurality of reference images y to m read by the image density sensor 25.

### (Exposure Amount Adjustment Process)

Next, in a state in which the developing voltage is adjusted to a set value, the control portion 90 forms a plurality of reference images y to m (see FIG. 3) in which the amount of toner adhesion is changed in steps by changing the exposure amount of the exposure device 5 (the toner adhesion area is thinned out) on the intermediate transfer belt 8. The exposure amount is changed by adjusting a drive voltage of the light source (LED) in the exposure device 5. The control portion 90 reads the formed reference images y to m using the image density sensor 25. The control portion 90 sets the exposure amount based on the voltage detected by the image density sensor 25. The set value (target value) of the exposure amount may be determined by linear interpolation by graphing the detected voltages of the plurality of reference images y to m read by the image density sensor 25.

### (Gradation Characteristic Adjustment Process)

Next, in a state in which the developing voltage and exposure amount are adjusted to the set values, the control portion 90 forms a plurality of reference images y to m, whose image densities are changed in steps by changing the toner adhesion area ratio, on the intermediate transfer belt 8. The toner adhesion area ratio is changed by adjusting the printing ratio of the reference images.

More specifically, the control portion 90, for colors (for example, cyan and magenta) for which the development voltage is set so that the image density is higher than the target density, calculates the toner adhesion area ratio for adjusting to the target density, and sets the calculated toner adhesion area ratio. For example, in a case where the area ratio (printing ratio) that reproduces the target density is 80%, the control portion 90 changes the printing ratio from 100% to 80% and forms the reference images. It is not necessary to change the area ratio (printing ratio) for a color (for example, yellow) for which the developing voltage is set so that the image density becomes the target density.

The control portion 90 reads the formed reference images y to m using the image density sensor 25. The control portion 90, based on the voltage detected by the image density sensor 25, corrects a lookup table indicating gamma characteristics for each color. The lookup table (gradation-density lookup table) is a table in the image forming apparatus 100 in which a gradation input value (exposure amount setting value) for each color and a corresponding output density target value are associated and stored.

Note that the developability of black toner is often significantly different from that of color toner. Therefore, in black image density correction, in the developing voltage adjustment process, the image density is set to a developing voltage that achieves the target density separately from the three colors above, and after that, the exposure amount adjustment process and gradation characteristic adjustment process are executed in the same manner. In black image density correction, it is not necessary to calculate the area ratio for achieving the target density.

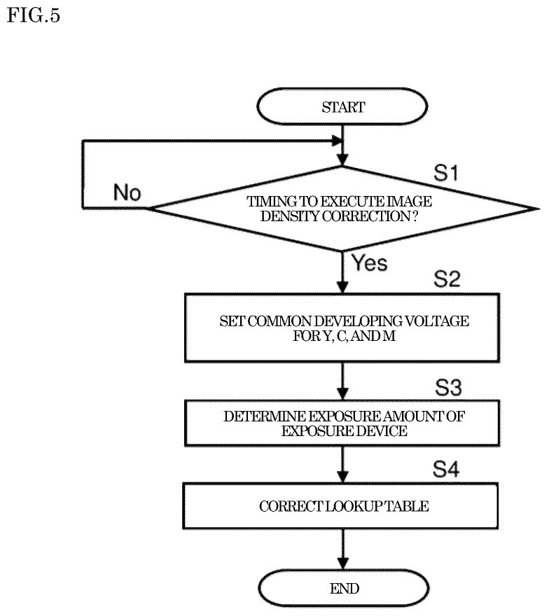

FIG. 5 is a flowchart showing an example of control of image density correction executed by the image forming apparatus 100 of the present embodiment. The image density correction procedure for the three colors of yellow, cyan, and magenta will be described following the steps in FIG. 5, and with reference to FIGS. 1 to 4 as necessary. Image density correction is performed when the power source of the image forming apparatus 100 is turned ON, when the cumulative number of printed sheets reaches a predetermined number, or when the installation environment (temperature and humidity) changes by a certain amount or more.

First, the control portion 90 determines whether or not it is time to execute image density correction (step S1). In a case where it is time to execute image density correction (YES in step S1), the control portion 90 determines a common developing voltage at which the image density of all three colors of yellow, cyan, and magenta is equal to or higher than the target density (step S2).

More specifically, the control portion 90 forms reference images y to m in the reference image forming area Rs (see FIG. 3) of the intermediate transfer belt 8 by changing the developing voltage (DC voltage) in steps, and reads the reference images by the image density sensor 25. The control portion 90 sets the developing voltage based on the voltage detected by the image density sensor 25 or by linearly interpolating the detected voltage.

Next, the control portion 90 determines the exposure amount of the exposure device 5 (step S3). More specifically, the control portion 90 forms the reference images y to k on the reference image forming area Rs of the intermediate transfer belt 8 by changing the exposure amount in steps, and reads the reference images with the image density sensor 25. The control portion 90 sets the exposure amount based on the voltage detected by the image density sensor 25 or by linearly interpolating the detected voltage.

Next, the control portion 90 corrects the lookup table indicating gamma characteristics for each color (step S4). More specifically, for colors whose image density exceeds the target density when the developing voltage is set in step S2 is applied, the control portion 90 calculates the toner adhesion area ratio (printing ratio) for adjusting the image density to the target density.

The control portion 90 forms reference images y to m, whose image densities are changed in steps using the calculated area ratio (printing ratio), on the reference image forming area Rs of the intermediate transfer belt 8, and reads the reference images by the concentration sensor 25. The control portion 90 corrects the lookup table based on the voltage detected by the image density sensor 25, and ends the image density correction.

According to the control example shown in FIG. 5, a common developing voltage is set for three colors, yellow, cyan, and magenta so that the image density becomes equal to or higher than the target density. For colors whose image density exceeds the target density when the set developing voltage is applied, the image density is adjusted to the target density by adjusting the toner adhesion area ratio.

Thus, it is possible to eliminate the need to separately provide control circuits for setting developing voltages for the three colors of yellow, cyan, and magenta, making it possible to reduce the circuit size of the voltage control circuit 71. Therefore, the number of electronic components of the voltage control circuit 71 can be reduced, contributing to simplification of the control path of the image forming apparatus 100 and cost reduction.

In addition, the technique according to the present disclosure is not limited to the above embodiments, and various changes can be made without departing from the spirit of the present disclosure. For example, in the above embodiment, a common developing voltage is set for the three colors yellow, cyan, and magenta; however, a common developing voltage may be set for any two colors among yellow, cyan, and magenta. In addition, in a case where the developability of black toner is close to that of the other three colors, a common developing voltage may be set for the four colors of yellow, cyan, magenta, and black.

Moreover, in the embodiments described above, an image forming apparatus 100 equipped with two-component developing type developing devices 3a to 3d that use a two-component developing agent including a magnetic carrier and a toner is described; however, the technique according to the present disclosure is similarly applicable to a magnetic one-component development method that uses magnetic toner or an image forming apparatus equipped with a non-magnetic one-component developing device.

Furthermore, the technique according to the present disclosure is applicable not only to the tandem color printer as shown in FIG. 1, but also to various image forming apparatuses that use toners of multiple colors, such as color copying machines, color multifunction peripherals, and the like.

The present disclosure can be used in a color image forming apparatus that uses toner of multiple colors. By utilizing the technique according to the present disclosure, it is possible to provide an image forming apparatus that is able to simplify a control circuit required to perform calibration for multiple color toners with different developability.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a plurality of image forming portions, each having
an image-carrying member with a photosensitive layer formed on a surface thereof;
a charging device configured to charge the surface of the image-carrying member; and
a developing device configured to develop an electrostatic latent image formed on the image-carrying member into a toner image using a developing-agent-carrying member carrying a developing agent including a toner;
the plurality of image forming portions configured to perform image formation using the toners of a plurality of colors with different developability;
an exposure device configured to expose the surface of the image-carrying member charged by the charging device to form the electrostatic latent image in which charging is attenuated;
an image density sensor configured to detect density of the toner image formed by the image forming portion;
a developing voltage supply mechanism configured to apply a developing voltage to the developing-agent-carrying member; and
a control portion configured to control the developing voltage supply mechanism and the exposure device; wherein
the control portion,
by the image density sensor detecting density of reference images for image density correction formed by a plurality of the image forming portions and adjusting the developing voltage and an exposure amount of the exposure device based on the detection result, is capable of executing image density correction to adjust image density in the plurality of image forming portions;
the control portion,
based on the density of the reference images detected by the image density sensor, sets the developing voltages in common such that the density of the reference images is equal to or higher than a target density in all of the two or more image forming portions selected from the plurality of image forming portions; and,
by adjusting an adhesion area ratio of the toner for the image forming portions of two or more selected image forming portions in which the densities of the reference images exceed the target density when a common developing voltage is set, adjusts the densities of the reference images to the target density.

2. The image forming apparatus according to claim 1, wherein
the control portion adjusts the adhesion area ratio of the toner by changing a printing ratio of the reference image.

3. The image forming apparatus according to claim 2, wherein
the image density correction includes:
a developing voltage adjustment process of the image density sensor detecting the density of the reference image formed by changing the developing voltage in a plurality of steps, and setting the developing voltage in common based on the detection result;
an exposure amount adjustment process of the image density sensor detecting the density of the reference image formed by changing the exposure amount in a plurality of steps, and setting the exposure amount based on the detection result; and
a gradation characteristic adjustment process of the image density sensor detecting the density of the reference image formed by changing the adhesion area ratio of the toner in a plurality of steps, and correcting a lookup table indicating gamma characteristics based on the detection result; and
the control portion, in the gradation characteristic adjustment process, by changing the printing ratio of the reference images for the image forming portions in which the densities of the reference images exceed the target density, adjusts the densities of the reference images to the target density.

4. The image forming apparatus according to claim 1, wherein
the control portion, in all of the image forming portions of the plurality of image forming portions that perform image formation using the toner other than black, sets the developing voltage in common such that the densities of the reference images are equal to or higher than the target density.

5. The image forming apparatus according to claim 1, further comprising
an intermediate transfer body to which the toner images formed by the image forming portions are primarily transferred; and wherein
the image density sensor detects the density of the reference images transferred onto the intermediate transfer body.
